(19) United States
(12) Patent Application Publication
(10) Pub. No.: US 2025/0141655 A1
(43) Pub. Date: May 1, 2025

(54) APPARATUS FOR DEFENDING AGAINST SIDE-CHANNEL ATTACKS IN BATTERY MANAGEMENT SYSTEM AND METHOD THEREOF

(71) Applicant: Samsung SDI Co., Ltd., Yongin-si (KR)

(72) Inventor: Min Su KIM, Suwon-si (KR)

(21) Appl. No.: 18/925,382

(22) Filed: Oct. 24, 2024

(30) Foreign Application Priority Data
Oct. 26, 2023 (KR) 10-2023-0144719

(51) Int. Cl. H04L 9/00

(52) U.S. Cl. CPC H04L 9/003

(57) ABSTRACT

An apparatus for defending against a side-channel attack in a battery management system includes an encryption operation module configured to perform and manage encryption operations on data related to monitoring and charge and discharge management of a battery in the battery management system, and a processor configured to process the encryption operations on the data using a plurality of cores according to management of the encryption operation module, wherein the encryption operation module performs the encryption operations in parallel by utilizing the plurality of cores of the processor.

### CROSS-REFERENCE TO RELATED APPLICATION

This application claims priority to and the benefit of Korean Patent Application No. 10-2023-0144719, filed on Oct. 26, 2023, the disclosure of which is incorporated herein by reference in its entirety.

### BACKGROUND

### 1. Field

Embodiments relate to an apparatus and method for defending against a side-channel attack in a battery management system.

### 2. Description of the Related Art

Generally, a battery management system (BMS) monitors the charging status, voltages, and temperatures of batteries in order to optimize the performance of a battery pack, ensures battery safety, extends battery life, and manages charging and discharging of batteries on the basis of results of the monitoring.

Further, a BMS ensures battery safety by preventing overcharging, over discharging, overheating, or the like of the battery.

A BMS may have a wireless communication capability, which allows battery status information to be remotely monitored and the BMS to be remotely controlled.

Although such a wireless BMS provides convenience and flexibility in battery management, the wireless BMS has a problem of poor security against side-channel attacks.

A side-channel attack is an attack based on a method of extracting encryption information using physical properties of hardware and may recover encryption keys by analyzing the power consumption patterns of a processor, and an embedded system such as a BMS is particularly vulnerable to such a side-channel attack.

Accordingly, there is a need for a technique for defending against side-channel attacks.

The above-described information disclosed in the related art of the present disclosure is only for improving understanding of the related art of the present disclosure.

### SUMMARY

Embodiments include an apparatus for defending against a side-channel attack in a battery management system, the apparatus including an encryption operation module configured to perform and manage encryption operations on data related to monitoring and charge and discharge management of a battery in the battery management system, and a processor configured to process the encryption operations on the data using a plurality of cores according to management of the encryption operation module, wherein the encryption operation module performs the encryption operations in parallel by utilizing the plurality of cores of the processor.

The encryption operation module may include a plurality of virtualized encryption operation-specific containers.

The encryption operation module may randomly use a plurality of encryption algorithms using the plurality of virtualized encryption operation-specific containers.

The encryption operation module may perform the encryption operations by assigning encryption algorithms that are randomly selected from among the plurality of encryption algorithms to the plurality of virtualized encryption operation-specific containers.

The encryption operation module may divide input data into a plurality of pieces of data for performing the encryption operations on the plurality of pieces of data.

The encryption operation module may randomly select a piece of data from among the plurality of pieces of data and assigns the randomly selected piece of data to one of a plurality of virtualized encryption operation-specific containers to process the encryption operations for each of the plurality of pieces of data.

The encryption operation module may randomly assign the encryption operations to the plurality of cores of the processor in order to process each of the encryption operations for each of the plurality of pieces of data using the plurality of virtualized encryption operation-specific containers.

If the encryption operations are completed for each of the plurality of pieces of data using the plurality of virtualized encryption operation-specific containers, the encryption operation module may combine result values obtained by performing the encryption operations and outputs final encrypted data.

Embodiments include a method of defending against a side-channel attack in a battery management system, the method including performing and managing, by an encryption operation module, encryption operations on data related to monitoring, charge and discharge management of a battery in the battery management system, and processing, by a processor, the encryption operations on the data using a plurality of cores of the processor according to management of the encryption operation module, wherein, in the processing of the encryption operations, the encryption operation module performs the encryption operations in parallel by utilizing the plurality of cores of the processor.

In the performing and managing of the encryption operations on the data, the encryption operation module may include a plurality of virtualized encryption operation-specific containers.

In the performing and managing of the encryption operations on the data, the encryption operation module may randomly use a plurality of encryption algorithms using the plurality of virtualized encryption operation-specific containers.

In the performing and managing of the encryption operations on the data, the encryption operation module may perform the encryption operations by assigning encryption algorithms that are randomly selected from among the plurality of encryption algorithms to the plurality of virtualized encryption operation-specific containers.

In the performing and managing of the encryption operations on the data, the encryption operation module may divide the data into a plurality of pieces of data for performing the encryption operations on the plurality of pieces of data.

In the performing and managing of the encryption operations on the data, the encryption operation module may randomly select a piece of data from among the plurality of pieces of data and assigns the randomly selected piece of data to a plurality of virtualized encryption operation-specific containers to process the encryption operations for each of the plurality of pieces of data.

The encryption operation module may randomly assign the encryption operations to the plurality of cores of the processor in order to process the encryption operation for each of the plurality of pieces of data using the plurality of virtualized encryption operation-specific containers.

If the encryption operations are completed for each of the plurality of pieces of data using the plurality of virtualized encryption operation-specific containers, the encryption operation module may combine result values obtained by performing the encryption operations and may output final encrypted data.

### BRIEF DESCRIPTION OF THE DRAWINGS

Features will become apparent to those of ordinary skill in the art by describing in detail exemplary embodiments with reference to the attached drawings, in which:

FIG. 1 is an exemplary diagram illustrating a schematic configuration of an apparatus for defending against a side-channel attack in a battery management system according to one or more embodiments of the present disclosure; and

FIG. 2 is a flowchart for describing a method of defending against a side-channel attack in a battery management system according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that if a layer or element is referred to as being “on” another layer or substrate, it can be directly on the other layer or substrate, or intervening layers may also be present. Further, it will be understood that if a layer is referred to as being “under” another layer, it can be directly under, and one or more intervening layers may also be present. In addition, it will also be understood that if a layer is referred to as being “between” two layers, it can be the only layer between the two layers, or one or more intervening layers may also be present. Like reference numerals refer to like elements throughout.

Hereinafter, exemplary embodiments of the present disclosure will be described in detail with reference to the accompanying drawings. Prior to description of this specification, terms and words used in this specification and claims should not be interpreted as being limited to commonly used meanings or meanings in dictionaries and should be interpreted with meanings and concepts which are consistent with the technological scope of the present disclosure based on the principle that the inventors have appropriately defined concepts of terms in order to describe the present disclosure in the best way.

Therefore, since the embodiments described in this specification and configurations illustrated in the drawings are only exemplary embodiments and do not represent the overall technological scope of the present disclosure, it is understood that the present disclosure covers various equivalents, modifications, and substitutions at the time of filing of this application. Further, it will be understood that the terms “comprise,” “include,” “comprising,” and/or “including,” used herein specify the presence of stated shapes, integers, steps, operations, members, elements, and/or groups thereof but do not preclude the presence or addition of one or more other shapes, integers, steps, operations, members, elements, and/or groups thereof. Further, in describing the embodiments of the present disclosure, the expressions “may do” and “may be” may mean that “one or more embodiments of the present disclosure” is included.

If two objects of comparison are described as being “the same,” this means that the objects are “substantially the same.” Therefore, “substantially the same” can include a deviation that is considered low in the art, for example, a deviation within 5%. In addition, uniformity of a parameter in a certain area may mean uniformity from an average perspective.

It should be understood that, although the terms “first,” “second,” etc. may be used herein to describe various components, these components are not limited by these terms. The terms are only used to distinguish one component from another component, and thus it should be understood that a first component may also be a second component unless otherwise stated.

Throughout the specification, unless otherwise stated, each component may be singular or plural.

If a first component is referred to as being disposed “above (or below)” or “on (or under)” a second component, this may mean that not only is the first component disposed in contact with an upper surface of (or a lower surface) of the second component, but also a third component may be interposed between the first component and the second component disposed on (or under) the first component.

Further, it should be understood that if a first component is referred to as being “connected to” or “coupled to” a second component, the first and second components may be directly connected to each other, but a third component may be interposed between the first and second components or the first and second components may be connected or coupled to each other through a third component. Further, if a first portion is referred to as being electrically connected (electrically coupled) to a second portion, this means that not only are the first and second portions directly connected to each other, but also the first and second portions are connected to each other with a third portion therebetween.

The expression “A and/or B” throughout the specification means A, B, or A and B unless otherwise stated. That is, the term “and/or” includes any and all combinations of one or more of the associated listed items. The expression “C to D” means C or more and D or less.

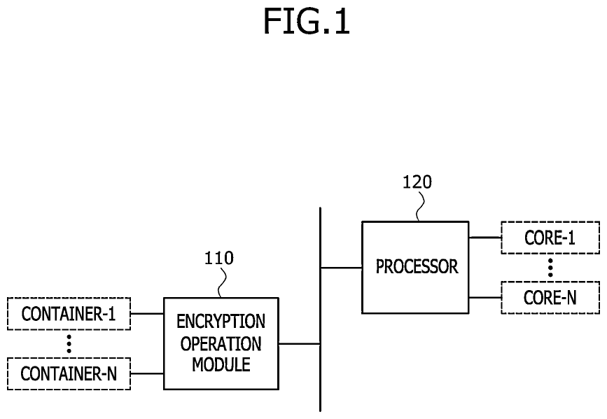

FIG. 1 is an exemplary diagram illustrating a schematic configuration of an apparatus for defending against a side-channel attack in a battery management system according to one or more embodiments of the present disclosure.

As illustrated in FIG. 1, the apparatus for defending against a side-channel attack in the battery management system according to one or more embodiments includes an encryption operation module 110 and a processor 120.

The encryption operation module 110 may perform and manage encryption operations on data.

The encryption operation module 110 may perform the encryption operations using a designated encryption algorithm.

The encryption operation module 110 may include a plurality of virtualized encryption operation-specific containers CONTAINER-1 to CONTAINER-N.

The plurality of virtualized encryption operation-specific containers CONTAINER-1 to CONTAINER-N included in the encryption operation module 110 may randomly use various encryption algorithms without being limited to any one encryption algorithm.

The encryption operation module 110 may receive data (e.g., data to be encrypted) and may divide the data into a plurality of pieces of data.

The encryption operation module 110 may randomly select a piece of data from among the plurality of pieces of data and may assign the randomly selected piece of data to one of the plurality of virtualized encryption operation-specific containers.

Each container of the encryption operation module 110 may perform an operation (i.e., an encryption operation) using a randomly selected encryption algorithm.

In embodiment(s), the operations (i.e., encryption operations) may be randomly assigned to a plurality of cores of the processor.

If all the operations (i.e., encryption operations) are completed, the encryption operation module 110 may combine result values obtained by performing the operations on the plurality of pieces of data and may output final encrypted data.

In some embodiments, the encryption operation module 110 may be implemented as a separate processor.

The processor 120 may execute an algorithm (or encrypted algorithm) for monitoring and managing a charging and discharging status of a battery.

The processor 120 may perform encryption operations in parallel by utilizing a plurality of cores CORE-1 to CORE-N.

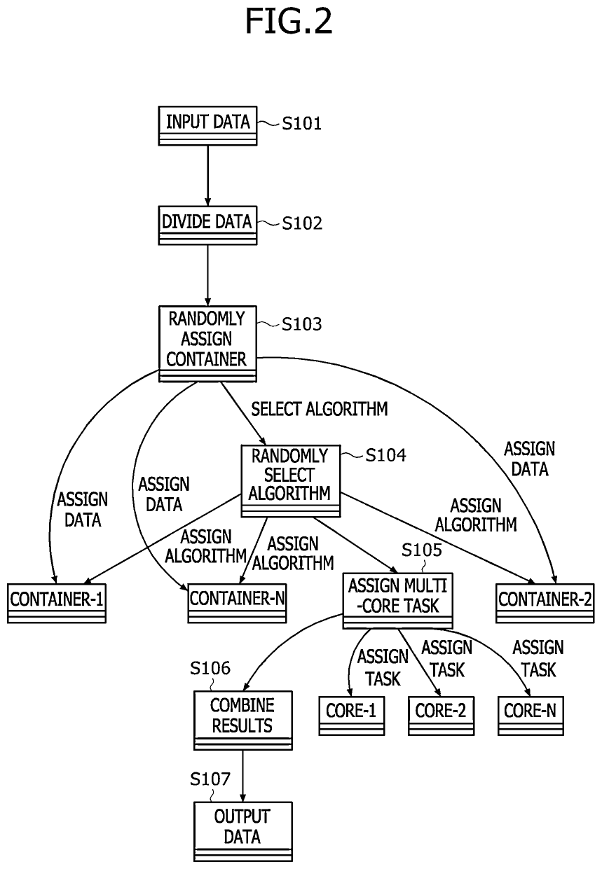

FIG. 2 is an exemplary flowchart for describing a method of defending against a side-channel attack in a battery management system according to one or more embodiments of the present disclosure.

Referring to FIG. 2, if data (e.g., data to be encrypted) is input (S101), an encryption operation module 110 may divide the data into a plurality of pieces of data (S102).

For example, the number of pieces of data divided by the encryption operation module 110 may be determined based on the number of containers, but the present disclosure is not limited thereto and the number of pieces of data can be a different number than the number of containers.

The encryption operation module 110 may randomly select a piece of data from among the plurality of pieces of data and may randomly assign the randomly selected piece of data to a plurality of virtualized encryption operation-specific containers CONTAINER-1 to CONTAINER-N (S103).

The encryption operation module 110 may randomly select various encryption algorithms and assign the randomly selected encryption algorithms to the plurality of virtualized encryption operation-specific containers CONTAINER-1 to CONTAINER-N to which the plurality of pieces of data are assigned (S104).

Accordingly, each container (i.e., each container to which the plurality of pieces of data is assigned) of the encryption operation module 110 may perform an operation (i.e., an encryption operation) on the data that is assigned using the randomly selected encryption algorithm.

The encryption operation module 110 may randomly select a plurality of cores CORE-1 to CORE-N of a processor 120 and may assign the operations (i.e., encryption operations) of the respective containers to the plurality of selected cores (S105).

Accordingly, a side-channel attacker cannot know which core among the plurality of cores CORE-1 to CORE-N of the processor 120 performs the operation (i.e., the encryption operation) on which container.

If the operations (i.e., encryption operations) that are assigned to the plurality of cores CORE-1 to CORE-N of the processor 120 are completed, the encryption operation module 110 may combine result values obtained by performing the operations on the plurality of pieces of data, according to assigned task schedules (S106).

If the combination of the result values obtained by performing the operations (i.e., encryption operations) on the divided data is completed, the encryption operation module 110 may output final encrypted data (S107).

As described above, the present disclosure provides an apparatus and method for defending against side-channel attacks by obfuscating power consumption patterns that are generated during encryption operations and making it difficult for attackers to analyze the power consumption patterns.

The present disclosure includes a multi-core processor and virtualized encryption operation-specific containers, and distributes encryption operations using a plurality of cores and algorithms, and thus the present disclosure can be applied to various applications and systems, in particular, embedded systems (e.g., battery management systems) having a wireless communication function, thereby improving both security and performance.

Compared to a method of performing encryption operations using a single core and a single algorithm or a method of obfuscating power consumption patterns by adding a dummy operation, the present disclosure has an effect of significantly reducing the risk caused by side-channel attacks by making power consumption patterns more complex and unpredictable.

The present disclosure has an effect of improving security while preventing a negative impact on the performance of encryption operations.

As described above, the present disclosure may be applied to embedded systems (e.g., wireless battery management systems) having a wireless communication function, the present disclosure may perform a plurality of encryption operations in parallel using virtualization technology, the present disclosure may be applied to Internet of Things (IoT) devices to enable encryption operations to be rapidly and safely performed through a multi-core processor, and thus the present disclosure has an effect of maintaining or improving performance while improving the security of the encryption operations.

The present disclosure is directed to an apparatus and method for defending against a side-channel attack in a battery management system that can defend against the side-channel attack by obfuscating power consumption patterns.

The present disclosure is also directed to an apparatus and method for defending against a side-channel attack in a battery management system that can defend against the side-channel attack using a multi-core processor and virtual containers in a battery management system.

However, effects that can be achieved through the present disclosure are not limited to the above-described effects and other effects that are not described may be clearly understood by those skilled in the art from the above detailed descriptions.

The implementations described herein may be implemented, for example, as a method or process, an apparatus, a software program, a data stream, or a signal. Although discussed only in the context of a single form of implementation (e.g., only as a method), the discussed features may also be implemented in other forms (e.g., devices or programs). The apparatuses may be implemented in appropriate hardware, software, firmware, etc. The methods may be implemented in devices such as processors, which generally refer to processing devices that include computers, microprocessors, integrated circuits, programmable logic devices, etc. Further, the processors include communication devices such as computers, cellular phones, portable/personal digital assistants (PDAs), other devices, etc. that facilitate the communication of information between end-users.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An apparatus for defending against a side-channel attack in a battery management system, the apparatus comprising:
an encryption operation module configured to perform and manage encryption operations on data related to monitoring and charge and discharge management of a battery in the battery management system; and
a processor configured to process the encryption operations on the data using a plurality of cores according to management of the encryption operation module,
wherein the encryption operation module performs the encryption operations in parallel by utilizing the plurality of cores of the processor.

2. The apparatus as claimed in claim 1, wherein the encryption operation module includes a plurality of virtualized encryption operation-specific containers.

3. The apparatus as claimed in claim 2, wherein the encryption operation module randomly uses a plurality of encryption algorithms using the plurality of virtualized encryption operation-specific containers.

4. The apparatus as claimed in claim 3, wherein the encryption operation module performs the encryption operations by assigning encryption algorithms that are randomly selected from among the plurality of encryption algorithms to the plurality of virtualized encryption operation-specific containers.

5. The apparatus as claimed in claim 1, wherein the encryption operation module divides input data into a plurality of pieces of data for performing the encryption operations on the plurality of pieces of data.

6. The apparatus as claimed in claim 5, wherein the encryption operation module randomly selects a piece of data from among the plurality of pieces of data and assigns the randomly selected piece of data to one of a plurality of virtualized encryption operation-specific containers to process the encryption operations for each of the plurality of pieces of data.

7. The apparatus as claimed in claim 6, wherein the encryption operation module randomly assigns the encryption operations to the plurality of cores of the processor in order to process each of the encryption operations for each of the plurality of pieces of data using the plurality of virtualized encryption operation-specific containers.

8. The apparatus as claimed in claim 7, wherein, if the encryption operations are completed for each of the plurality of pieces of data using the plurality of virtualized encryption operation-specific containers, the encryption operation module combines result values obtained by performing the encryption operations and outputs final encrypted data.

9. A method of defending against a side-channel attack in a battery management system, the method comprising:
performing and managing, by an encryption operation module, encryption operations on data related to monitoring, charge and discharge management of a battery in the battery management system; and
processing, by a processor, the encryption operations on the data using a plurality of cores of the processor according to management of the encryption operation module,
wherein, in the processing of the encryption operations, the encryption operation module performs the encryption operations in parallel by utilizing the plurality of cores of the processor.

10. The method as claimed in claim 9, wherein, in the performing and managing of the encryption operations on the data, the encryption operation module includes a plurality of virtualized encryption operation-specific containers.

11. The method as claimed in claim 10, wherein, in the performing and managing of the encryption operations on the data, the encryption operation module randomly uses a plurality of encryption algorithms using the plurality of virtualized encryption operation-specific containers.

12. The method as claimed in claim 11, wherein, in the performing and managing of the encryption operations on the data, the encryption operation module performs the encryption operations by assigning encryption algorithms that are randomly selected from among the plurality of encryption algorithms to the plurality of virtualized encryption operation-specific containers.

13. The method as claimed in claim 9, wherein, in the performing and managing of the encryption operations on the data, the encryption operation module divides the data into a plurality of pieces of data for performing the encryption operations on the plurality of pieces of data.

14. The method as claimed in claim 13, wherein, in the performing and managing of the encryption operations on the data, the encryption operation module randomly selects a piece of data from among the plurality of pieces of data and assigns the randomly selected piece of data to one of a plurality of virtualized encryption operation-specific containers to process the encryption operations for each of the plurality of pieces of data.

15. The method as claimed in claim 14, wherein the encryption operation module randomly assigns the encryption operations to the plurality of cores of the processor in order to process the encryption operation for each of the plurality of pieces of data using the plurality of virtualized encryption operation-specific containers.

16. The method as claimed in claim 15, wherein, if the encryption operations are completed for each of the plurality of pieces of data using the plurality of virtualized encryption operation-specific containers, the encryption operation module combines result values obtained by performing the encryption operations and outputs final encrypted data.
